(19) United States
(12) Patent Application Publication
(10) Pub. No.: US 2025/0238469 A1
(43) Pub. Date: Jul. 24, 2025

(54) METHODS AND SYSTEMS FOR IDENTIFYING CONTEXT WITHIN MEDIA STREAMS

(71) Applicant: TuneIn, Inc., San Francisco, CA (US)

(72) Inventors: Abraham Ben-Tov, San Francisco, CA (US); Sarah Emerson, San Francisco, CA (US); Mehul Gupta, San Francisco, CA (US); Sridhar Subramanian, San Francisco, CA (US)

(21) Appl. No.: 19/034,114

(22) Filed: Jan. 22, 2025

Related U.S. Application Data
(60) Provisional application No. 63/623,854, filed on Jan. 23, 2024.

(51) Int. Cl. G06F 16/953

(52) U.S. Cl. CPC G06F 16/953

(57) ABSTRACT

Disclosed embodiments may provide systems and methods for identifying context within media streams. According to some embodiments, a computer-implemented method is provided. The computer-implemented method includes receiving an identification of a set of communication channels presenting media content and identifying current media content being presented over the set of communication channels. The method may further include generating one or more keywords associated with the current media content with a machine-learning model trained to interpret natural language associated with the current media content. The method may further include receiving, from the user device, a search query. The method may further include generating one or more recommended communication channels. The one or more recommended communication channels are associated with one or more keywords similar to the search query. The method may further include presenting the one or more recommended communication channels on the user device.

### CROSS-REFERENCE TO RELATED APPLICATIONS

This application claims priority to and the benefit of U.S. Provisional Application No. 63/623,854, filed Jan. 23, 2024, titled “METHODS AND SYSTEMS FOR IDENTIFYING CONTEXT WITHIN MEDIA STREAMS,” the disclosure of which is hereby incorporated by reference in its entirety.

### TECHNICAL FIELD

This disclosure relates generally to identifying context within media streams, and more particularly to generating one or more keywords associated with current media content and responding to a search query using the one or more keywords.

### BACKGROUND

Traditional analog radio stations for generic user listening are limited to a specific bandwidth range set by the government. Analog radios may receive transmissions from broadcasting stations within the specific bandwidth range and may output a channel associated with a bandwidth selected by a user. Since the specific bandwidth range is known, the frequencies associated with a broadcast station can be identified by identifying frequencies associated with a high signal to noise ratio. However, identifying particular frequency ranges does not provide an indication of what media is being broadcast by the broadcast station. As broadcasters begin broadcasting over other communication channels (e.g., the Internet), identifying broadcast stations or the media broadcast by particular broadcast stations may be even more difficult and complex.

### SUMMARY

Methods described herein for identifying context within media streams. In some examples, the method includes receiving an identification of a set of communication channels presenting media content and identifying current media content being presented over the set of communication channels. The method may further include generating one or more keywords associated with the current media content. The one or more keywords may be generated by a machine-learning model trained to interpret natural language associated with the current media content. The method may further include receiving, from the user device, a search query. The method may further include generating one or more recommended communication channels. The one or more recommended communication channels are associated with one or more keywords similar to the search query. The method may further include presenting the one or more recommended communication channels on the user device.

In some examples, the method may further include generating, according to the one or more keywords, a subset of communication channels. The subset of communication channels may be associated with a duration of time. After the duration of time, the method may further include identifying updated current media content being presented over the subset of communication channels. The method may further include generating one or more updated keywords associated with the current media content.

In some examples, the method may further include receiving, from the user device, feedback associated with the one or more recommended communication channels and updating the machine-learning model according to the feedback.

In some examples, the method may further include that the one or more keywords are generated by receiving data from the set of communication channels.

In some examples, the method may further include that the one or more recommended communication channels are further generated based on user data, wherein the user data includes at least a user profile associated with the user device.

In some examples, the method may further include that the machine-learning model was trained using transfer learning.

In some examples, the method may further include that the one or more keywords comprises at least one of a song title, a song categorization, a topic of discussion, a subject matter, names of one or more hosts, original broadcast location of a media source, or title of programming.

Systems are described herein for identifying context within media streams. The systems may comprise one or more processors and a memory storing instructions that, as a result of being executed by the one or more processors, cause the system to perform any of the aforementioned methods.

Non-transitory computer-readable storage media are described herein that store instructions therein that, as a result of being executed by one or more processors, cause the one or more processors to perform any of the aforementioned methods.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Features, embodiments, and advantages of the present disclosure are better understood when the following Detailed Description is read with reference to the accompanying drawings.

FIG. 1 illustrates an example block diagram for a system capable of identifying context within media streams, according to aspects of the present disclosure.

FIG. 2 illustrates an example computing environment for identifying context within media streams using machine-learning techniques, according to aspects of the present disclosure.

FIG. 3 illustrates an example computing environment for a content-provider system identifying context within media streams using machine-learning techniques, according to aspects of the present disclosure.

FIG. 4 illustrates an example computing environment for a content-provider system identifying context within media streams based on output generated from a special-purpose computer, according to aspects of the present disclosure.

FIG. 5 illustrates an example process for identifying context within media streams using machine-learning techniques, according to aspects of the present disclosure.

FIG. 6 shows a computing system architecture, including various components in electrical communication with each other, according to aspects of the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Systems and methods are described herein for identifying context within media streams using machine-learning techniques. In some examples, a media-streaming application may connect to one or more communication channels via a network. Through the network, the media-streaming application may receive data corresponding to a media content schedule. The media content schedule may include data pertaining to media programming, timing, duration of media programming, one or more keywords associated with the media programming, etc. The media-streaming application may generate one or more keywords associated with the current media content associated with a communication channel (e.g., genre of the current song playing on the communication channel, subject matter of a particular talk show transmitted from the communication channel, etc.). In some examples, the media-streaming application may generate the one or more keywords using one or more machine-learning models. The media-streaming application may employ a machine-learning model trained to interpret natural language to recognize current media content associated with a communication channel. For example, the machine-learning model may recognize a song, artist, album, subject matter of a talk show, or other streamed content being broadcast by the communication channel. The machine-learning model may then generate the one or more keywords associated with the current media content associated with the communication channel.

The media-streaming application may receive a query from a user device. The query may be directed at a request for particular media content. For example, a user may search for a particular song, artist, album, subject matter, current events, etc. The media-streaming application may generate a list of one or more recommended communication channels that are associated with current media content similar to the query from the user device. For example, the user device may receive a list of one or more communication channels that are currently broadcasting news pertaining to a particular news event, such as an election. After receipt of the list of one or more recommended communication channels, the user device may send an additional request to the media-streaming application to output a selected communication channel of the one or more recommended communication channels.

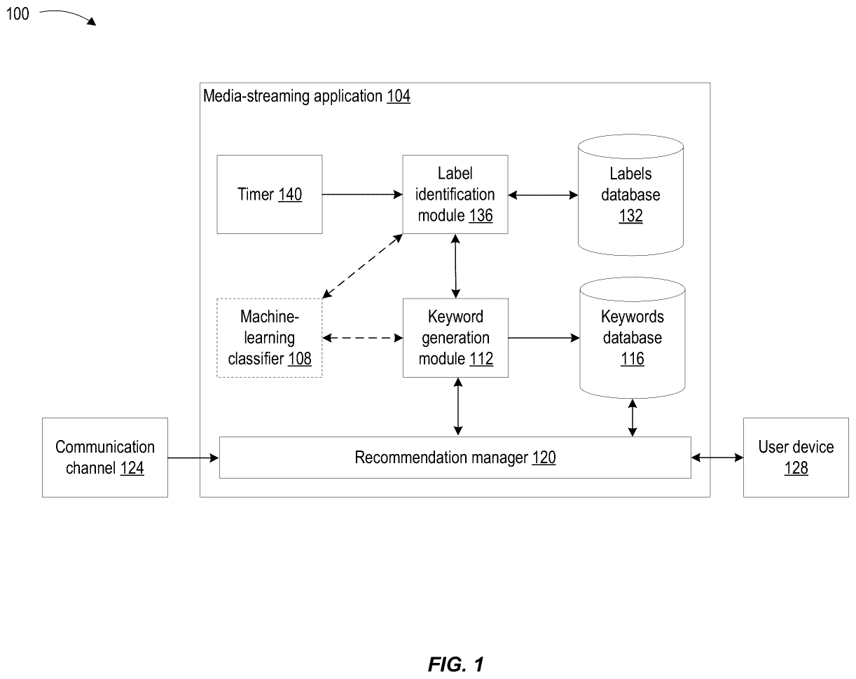

FIG. 1 illustrates an example block diagram 100 for a system capable of identifying context within media streams, according to some embodiments. A user device may execute a media-streaming application configured to connect to communication channels and present media being broadcast over the communication channels. A communication channel may be a medium over which media (e.g., audio, video, and/or the like) can be broadcast to one or more devices. Examples of communication channels can include, but are not limited to, broadcast radio (e.g., Amplitude Modulation (AM), Frequency Modulation (FM), Digital Audio Broadcasting (DAB), High Definition (HD) radio, Digital Radio Modiale (DRM), etc.), broadcast television, media streams (e.g., via the Internet, a webservice, a cloud service, one or more remote devices, etc.), combinations thereof, or the like. A media-streaming application 104 may include components such as, but not limited to, a recommendation manager 120, a machine-learning classifier 108, a keyword generation module 112, a timer 140, a label identification module 136, and databases (e.g., labels database 132 and keywords database 116). All components discussed herein may alone or in combination identify context within media streams. In some examples, the media-streaming application 104 may be located on a system that may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 104. The media-streaming application 104 may receive media streams, via the recommendation manager 120, corresponding to one or more communication channels, which may include the communication channel 124, over a network. The media streams may be transmitted or broadcasted by the one or more communication channels (e.g., physical location from which a media stream is broadcasted or transmitted such as, but not limited to, a radio station).

The recommendation manager 120 may transmit the media stream associated with the communication channel 124 to the keyword generation module 112. The keyword generation module 112 may generate one or more keywords associated with the media stream. The one or more keywords may pertain to the subject matter of the media stream (e.g., primary discussion topic of a talk show, type of sport, etc.), genre of the media stream (e.g., talk show, sports, morning programming, musical content, national news, local news, etc.), genre of musical content (e.g., country, pop, classical, EDM, etc.), names of individuals associated with the media streams (e.g., news anchors, players, talk show hosts, guests on talk shows, artists, composers, etc.), name of media stream (e.g., show titles, song titles, live stream titles, competing teams in a sports game, etc.), target audience of the media stream (e.g., age group, demographic, culture, etc.), any other descriptor of the media stream, any combination thereof, or the like.

In some examples, the recommendation manager 120 may receive data pertaining to the media stream, a schedule of current and/or future media content, a programming schedule, any combination thereof, or the like. The recommendation manager 120 may transmit this data to the keyword generation module 112. The keyword generation module 112 may use one or more processors to filter the data to determine elements of the data that are applicable to the media stream of the communication channel 124. The keyword generation module 112 may generate, using the filtered data, one or more keywords applicable to the media stream. The keyword generation module 112 may store the one or more keywords in the keywords database 116. The keywords database 116 may be stored in a location accessible to the media-streaming application 104, including, but not limited to, local memory, cloud storage, external memory, any combination thereof, or the like. The keywords database 116 may store the one or more keywords in associated with the media stream and/or the communication channel. For example, the keywords database 116 may be formatted as a table, thereby enabling the one or more keywords to be associated with the media stream and/or the communication channel via rows or columns.

In some examples, the keyword generation module 112 may generate the one or more keywords using the machine-learning classifier 108. The recommendation manager 120 may transmit the media stream to the keyword generation module 112. The media stream may include a song, a talk show, a sports game, any combination thereof, or the like. The keyword generation module 112 may transmit the media stream to the machine-learning classifier 108. The machine-learning classifier 108 may enable one or more machine-learning models trained to interpret natural language, recognize patterns in audio data, audio recognition, any combination thereof, or the like. For example, a first machine-learning model may receive the media stream and may identify a song and artist associated with the media stream.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. In some instances, the machine-learning model may be trained using training data received and/or derived from media streams previously presented by the user device 204. In some examples, the first machine-learning model may be trained using training data received and/or derived from one or more keywords associated with one or more communication channels. In some instances, the first machine-learning model may be trained using media streams associated with other user devices (e.g., such as other devices executing the media-streaming application). The first machine-learning model can be trained using supervised training, supervised training, semi-supervised training, reinforcement training, combinations thereof, or the like.

In some examples, the keyword generation module 112 and/or the media-streaming application 104 can define a time window usable to define a set of media segments. In some instances, the time window may be defined as “live” and correspond to a portion of the media stream extending from a current time backwards to a historical time. In other instances, the time window may be defined as “historical” and correspond to a portion of the media stream over a historical time interval. Media-streaming application 104 may define a set of media segments from the portion of the media stream that is within the time window. The length of each media segment of the set of media segments may be uniform (e.g., of a same length, etc.) or non-uniform (e.g., of a variable length, etc.) For example, each media segment may be defined to be input for a particular machine-learning model of the one or more machine-learning models of machine-learning classifier 108 to generate a one or more keywords of a particular type (e.g., referred to as a keyword type such as categorization, topic, key individual, etc.). The one or more machine-learning models may be trained to receive an input of a particular size (e.g., a minimum segment length of the media stream) to generate an output. Media-streaming application 104 may define each media segment of the set of media segments based on the particular machine-learning model that is to process that media segment.

The one or more machine-learning models may be trained to generate one or more keywords that characterize the media segment (and by extension, the portion of the media stream represented by the time window). In some examples, the one or more keywords may be generated according to a pre-determined keyword template, which may contain one or more types of keywords to be generated by the one or more machine-learning models. The pre-determined keyword template may be utilized to ensure uniformity amongst the one or more keywords associated with different media segments. For example, the one or more types of keywords may include, but are not limited to, categorization (e.g., music radio, talk radio, sports game, etc.), a title (e.g., an identifier of the communication channel, media segment, etc.), genre (e.g., comedy, politics, country music, pop music, morning talk radio, etc.), key individuals (e.g., key players on a team, pundits, anchors, hosts, artists, show guests, etc.), topics (e.g., election, pop culture, world news, sports news, etc.), a location (e.g., a country, a state, a region, a city, etc.), and/or any other relevant characteristic that may be associated with the content of the media segment. In addition to the one or more types of keywords, the one or more machine-learning models may generate additional keywords. The additional keywords may be types of keywords that may not broadly apply to all types of media segments (e.g., a score of a game, an album title, an “original air date,” a title, etc.).

In some examples, the one or more keywords may be organized in a hierarchy based on the keyword type. The hierarchy may be defined dynamically based on one or more factors such as an identification of a user for which the hierarchy may be implemented, historical communication channels associated with the user, keyword type specificity (e.g., based on the quantity of communication channels assigned a particular keyword, where a keyword associated with fewer quantity of communication channels may be considered more specific than keywords associated with a greater quantity of communication channels, etc.), characteristics common to a group of users, combinations thereof, or the like. For example, the hierarchy may be defined for a particular user based on historical communication channels associated with the particular user and the specificity of the keyword types. One particular user that connects to communication channels associated with one or more genres more frequently than communication channels associated with a particular location may cause the hierarchy to be defined with “genre” being positioned higher in the hierarchy than “location.” After generating the one or more keywords associated with the media segment, hierarchy can be applied to the one or more keywords. For example, a value or “score” may be generated for each of the one or more keywords (e.g., such as a real number value between 0 and 1, where 0 indicates a low level of importance and a 1 indicates the highest level of importance). The one or more keywords may be ordered into an ordered list, categorized into one or more classes (e.g., a “high,” “medium,” and/or “low” category), any combination thereof, or the like.

The label identification module 136 may receive the one or more keywords generated by the keyword generation module 112. The label identification module 136, using the one or more keywords, may assign a label to the media segment of the first time window. The label may by a categorization, such as music, talk radio, news, short-form talk radio (e.g., a morning show that plays a mixture of music and talk radio), football, soccer, basketball, commercial, any combination thereof, or the like. In some examples, the label may be determined according to the hierarchy applied to the one or more keywords. For example, the label identification module 136 may select a keyword of the one or more keywords associated with the highest value or “score,” ranked highest on the ordered list, and/or placed in a pre-defined category. In some other examples, the label may be determined by identifying a keyword of the one or more keywords that is associated with a specified type of keyword. For example, the label, for each media segment, may be determined according to the keyword associated with the “genre” of the media segment (e.g., sports, talk radio, music radio, etc.). The determined label may be stored in the labels database 132 in association with an associated communication channel and/or media segment.

In some examples, the label identification module 136 may utilize machine-learning classifier 108 to identify the label associated with the media segment. The machine-learning classifier 108 may select one or more machine-learning models trained to make inferences about a media stream according to one or more keywords associated with a media segment of the media stream. For example, the label identification module 136 may identify that the communication channel 124 is streaming a soccer game, thereby identifying the label “soccer.” The label identification module 136 may store the identified label and the associated communication channel 124 in the labels database 132.

In some examples, the media-streaming application 104 may use the label associated with a communication channel to define a sampling value that determines a frequency in which the keyword generation module 112 is to generate new keywords. For example, the label may be indicative of a time interval of the current programming of the communication channel 124. If the label indicates that the current programming is likely to extend until the end of the hour (e.g., such as a scheduled programing), then the media-streaming application 104 may reduce the frequency in which new keywords are generated (e.g., reducing the sampling value) until the end of the hour to reduce the processing resources consumed when generating keywords (e.g., because it is unlikely that the label indicative of the current programming will change before the end of the hour). At the end of the hour, the media-streaming application may return the sampling value to a default value until a new label is determined. The sampling value may cause a new one or more keywords to be generated every 30 second, 1 minute, 5 minutes, 30 minutes, 1 hour, any other time duration, or the like based on the label. The time duration associated with a label may be determined by user input (e.g., an administrator of the network, the user, etc.), programmed into the media-streaming application 104, the one or more machine-learning models, combinations thereof, or the like. The sampling value may be associated with a default value. The sampling value may be increased when the current label and/or the current time indicates that the current label likely to change within the next x minutes (where x is an integer that is greater than 0). The sampling value may be decreased when the current label and/or the current time indicates that the current label is unlikely to change within the next x minutes (where x is an integer that is greater than 0). The sampling value may return to the default value after a threshold time interval expires after the sampling value is increased or decreased.

In some examples, the label identification module 136 and/or the machine-learning classifier 108 may use data from one or more external sources (in addition to or in place of the label and/or time) to define the value of the sampling value (e.g., the default value, the increased value, the decreased value, etc.). For example, the label identification module 136 and/or the machine-learning classifier 108 may request a programming schedule associated with the communication channel 124 from the recommendation manager 120, the communication channel 124, an external database accessible by the media-streaming application 104, an Internet source, any combination thereof, or the like. As another example, the label identification module 136 and/or the machine-learning classifier 108 may query one or more external sources about the duration of a particular sports game (e.g., “average duration of an MLS soccer game,” average duration of an NFL football game,” “average duration of a classical composition,” “average duration of a pop song,” etc.). The label identification module 136 and/or the machine-learning classifier 108 may determine the sample value based on the label, the current time (e.g., a current contemporaneously generated timestamp, etc.), the data from external source, and/or the like. The sample value may also be stored in the labels database 132 with the identified label and the communication channel 123.

The label identification module 136 may utilize timer 140 with the sampling value to determine when to generate a new one or more keywords. The timer 140 may include one or more individual timers that can be selectively activated based on based on the label, the current time, the data from external source, and/or the like. For example, a first timer of timer 140 may be set to 5 minutes and may be associated with “song.” As another example, a second timer of timer 140 may be set to 45 minutes and may be associated with “soccer game.” In some examples, the timer 140 may consist of a clock that continually tracks the current time associated with the user device 128. In some instances, a timer may be defined based on a current time. For instance, some programming may be scheduled relative to the time of day (e.g., such as a program configured to begin at 2:00 PM and end at 2:30 PM, etc.). Timer 140 may define a timer based on the current time and a possible (or expected) termination of the current label. Timer 140 may generate an event when a timer expires that can be detected by other processes of the media-streaming application 104.

When an event is detected (corresponding to the expiration of a timer), the label identification module 136 may transmit a request to the keyword generation module 112 to generate a new one or more keywords. The keyword generation module 112 may generate a new one or more keywords from a new set of media segments corresponding to a new time window The keyword generation module 112 may pass the new one or more keywords to the label identification module 136, the keywords database 116, and/or any other component.

In some examples, the label identification module 136, the keywords database 116, and/or any other component receiving the new one or more keywords may prune existing data by replacing the existing data with the new one or more keywords. For example, if the new one or more keywords are received in association with a communication channel, the keywords database 116 may remove old keywords (e.g., one or more keywords generated using prior media segments associated with the communication channel) that may have been associated with the communication channel and may store the new one or more keywords in association with the communication channel. In a similar manner, label identification module 136 may remove old labels that may have been stored in association with a communication channel and based on prior media segments and may store a newly-generated label based on the new one or more keywords in association with the communication channel.

The user device 128 may query the media-streaming application 104 using one or more search terms and optionally one or more search operators. The recommendation manager 120 may receive the one or more search terms from the user device 128. The recommendation manager 120 may determine one or more keywords that correspond to the search terms by querying the keywords database 116 for a set of keywords in which each keyword is related to the query or a portion thereof to some degree. The recommendation manager 120 may utilize Boolean logic, neural networks, look-up tables, decision trees, machine-learning, and/or any other methods of defining a degree of relatedness between a keyword and a search term or phrase. For example, the recommendation manager 120 may identify matching keywords that match a word or phrase of the search term and associated keywords that do not exactly match but are related (e.g., such as the keyword “soccer” for the search term “Manchester United”). Examples of associated keywords include, but are not limited to, keywords that are more specific or less specific version of a search term (e.g., the keyword “classic rock” may be a generic keyword associated with the search term “ACDC,” or the keyword “soccer” may be a generic keyword associated with “Manchester United,” etc.), inferences associated with the one or more search terms (e.g., the keyword “Tim McGraw” may be identified from the search term “Garth Brooks”, etc.), keywords associated with corrected searched terms (e.g., corrected spelling or punctuation, etc.), keywords associated with an intent (e.g., keywords that correspond to a predicted intent of the query or search terms), keywords associated with a sentiment (e.g., keywords that correspond to same or similar predicted sentiment as the query or search terms), combinations thereof, or the like. The recommendation manager 120 may disregard keywords that may not be correlated with an intent of the query such as keywords identified from non-descriptive words, keywords identified from articles or other parts of speech, etc.), keywords that match too many communication channels (e.g., based on a threshold defined by a machine-learning model, user input, etc.). The recommendation manager 120 may assign a weight to each matching keyword and associated keyword based on the hierarchy.

The recommendation manager 120 may identify a set of communication channels associated with a label (or keywords) that matches the matching keywords and the associated keywords. The recommendation manager 120 may assign a score to the communication channels of the set of communication channels based on the weights assigned to the keywords of the query that match the keywords associated with the communication channel. The recommendation manager 120 may order the set of communication channels based on the score.

Alternatively, the query may be processed by the same machine-learning models used to generate the keywords to identify matching communication channels without first converting the query into keywords. The machine-learning models may parse the query into a feature vector and output the set of communication channels that are currently presenting media segments that correspond the query. The machine-learning model may also output a confidence value that corresponds to a degree in which the output communication channels correspond to the query (e.g., similar to the score assigned by the recommendation manager 120). The set of communication channels may be ordered based on the confidence value. In some instances, the recommendation manager 120 may remove communication channels from the set of communication channels that have a low confidence value (e.g., below a defined threshold) or reduce the set of communication channels to a predetermined quantity of communication channels by removing the communication channels with the lowest confidence value until a predetermined quantity of communication channels remain.

As an illustrative example, the user device 128 may transmit the search terms “Champions League final 2023” to the recommendation manager 120. The recommendation manager 120 may generate (using the keywords database 116) keywords such as, “Champions League”, “2023”, “final”, “Manchester City vs. Inter Milan”, “Union of European Football Associations”, “UEFA”, “European”, “soccer”, “football”, etc. The recommendation manager 120 may assign weights to the generated keywords based on the hierarchy. For example, keywords that are more specific may be assigned a higher weight than keywords that may be less specific. Keywords such as “Manchester City vs. Inter Milan,” “Champions League,” etc. may be weighted higher than keywords such as “UEFA,” “soccer,” etc. The recommendation manager 120 may identify communication channels that are assigned keywords that match at least one keyword of the generated keywords. The recommendation manager 120 may assign a score to the communication channels based on the keywords assigned to the communication channel that match at least one keyword of the generated keywords and the weights. The recommendation manager 120 may identify a first communication channel “Champions League final Manchester City vs. Inter Milan Jun. 10, 2023” based on the communication channel currently presenting content that is closely related to the higher weighted keywords. The recommendation manager 120 may also identify communication channels currently presenting topics associated with the soccer match between Manchester City vs. Inter Milan on Jun. 10, 2023 (e.g., such as talk radio, etc.), communication channels currently presenting other champions league games from 2023, communication channels currently presenting other champions league games, communication channels currently presenting European soccer matches, communication channels currently presenting a soccer match, communication channels currently presenting topics associated with soccer, etc. The identified communication channels may be ordered according to the degree in which the keywords match a communication channel (e.g., quantity of matching keywords and the weights assigned).

In the alternative, the recommendation manager 120 may identify the set of communication channels without one or more search terms and/or search operators from the user device 128. The recommendation manager 120 may determine one or more keywords that correspond to data associated with the user device 128. The data may be requested from media-streaming application 104, user device 128, one or more communication channels (e.g., communication channel 124), keyword generation module 112, keywords database 116, a third-party database, any combination thereof, or the like. The requested data may include information associated with a user profile associated with the user device 128 (e.g., a communication channel listening history, a demographic of a user, a geographic location of the user device 128), one or more additional user profiles that may not be associated with the user device 128 (e.g., a communication channel listening history of a “friend” user profile, “trending” or “popular” communication channels for a certain demographic, frequently-listened communication channels of a particular geographic region, data associated with a social network), interaction data associated with the user device 128, any combination thereof, or the like.

In some examples, the machine-learning model may generate one or more keywords associated with the requested data. The one or more keywords may be tailored to the user device 128 and/or the user profile associated with the user device 128 by accounting for listening preferences of the user device 128, listening preferences of similarly-situated user devices, listening preferences of a geographic region associated with the user device 128, any combination thereof, or the like. In addition to or in lieu of one or more keywords associated with the requested data, the machine-learning model may also assess the frequency of one or more keywords within the keywords database 116. The machine-learning model may identify a set of “trending” keywords or “popular” keywords associated with one or more communication channels stored within the keywords database 116. Trending keywords may refer keywords that appear frequently within the keywords database 116 over a recent time interval (e.g., a predetermined time interval extending from the present time instant such as, but not limited to, a half hour, an hour, 6 hours, a day, etc.). Popular keywords may refer keywords that appear frequently within the keywords database 116).

For example, the machine-learning model may identify that a threshold number of communication channels are transmitting media content associated with the keyword “soccer.” The set of “trending” or “popular” keywords may be updated periodically, such as daily, weekly, or hourly. In some examples, user device 128 may browse historical “trending” or “popular” keywords. For example, user device 128 may browse a subset of communication channels that previously presented content pertaining to a sporting event that occurred two weeks ago. User device 128 may access the previously-presented content of the subset of communication channels. In some examples, the historical “trending” or “popular” keywords may be presented to user device 128 as an interactive timeline, enabling browsing of the historical “trending” or “popular” keywords.

Using the one or more keywords associated with the requested data and/or the set of popular keywords associated with one or more communication channels, the recommendation manager 120 may identify the set of communication channels associated with a label (or keywords) that matches the one or more keywords associated with the requested data and/or the set of popular keywords. In some examples, the set of communication channels may be separated into one or more subsets of communication channels associated with a particular identifier according to relevant keywords (e.g., a topic, a genre, a theme, a personalized subset, etc.). For example, a first subset of communication channels may be identified as “For You,” indicating that the first subset is tailored to the user device 128 and/or the associated user profile. As another example, a second subset of communication channels may be identified as “Popular in Your Area,” indicating that the second subset includes one or more communication channels that are frequently listened to in a geographic region associated with the user device 128. As yet another example, a third subset of communication channels may be identified as “Trending,” indicating that the third subset includes one or more communication channels that are currently transmitting media content associated with “trending” or “popular” topics, such as a sporting event, a news story, a particular artist or album, etc. As yet another example, a fourth subset of communication channels may be identified according to a specific genre, such as “Rock Pop,” indicating that the fourth subset includes one or more communication channels that are currently transmitting media content associated with “rock pop”-genre music.

The recommendation manager 120 may present a predetermined quantity of communication channels of the set of communication channels and/or a subset of the communication channels via the user device 128. The media-streaming application 104 may present an indication of the one or more identified communication channels in the form of a list, graphic, a map, a wheel, overlay display, pop-up, grid, any combination thereof, or the like. In some instances, the recommendation manager 120 may also present the keywords that caused the recommendation manager 120 to identify and present the communication channel, the score assigned to the communication channel (e.g., indicating the degree in which the communication channel corresponds to the query), a ranking of the communication channel relative to other communication channels of the set of communication channels, etc. In some examples, user device 128 may transmit an indication to media-streaming application 104 distinguishing a particular subset of the communication channels. For example, user device 128 may “favorite,” “follow,” “like,” subscribe to notifications, any combination thereof, or the like, the particular subset (e.g., the particular subset includes a topic that is of interest to the user, the particular subset includes a favorite genre of music, etc.).

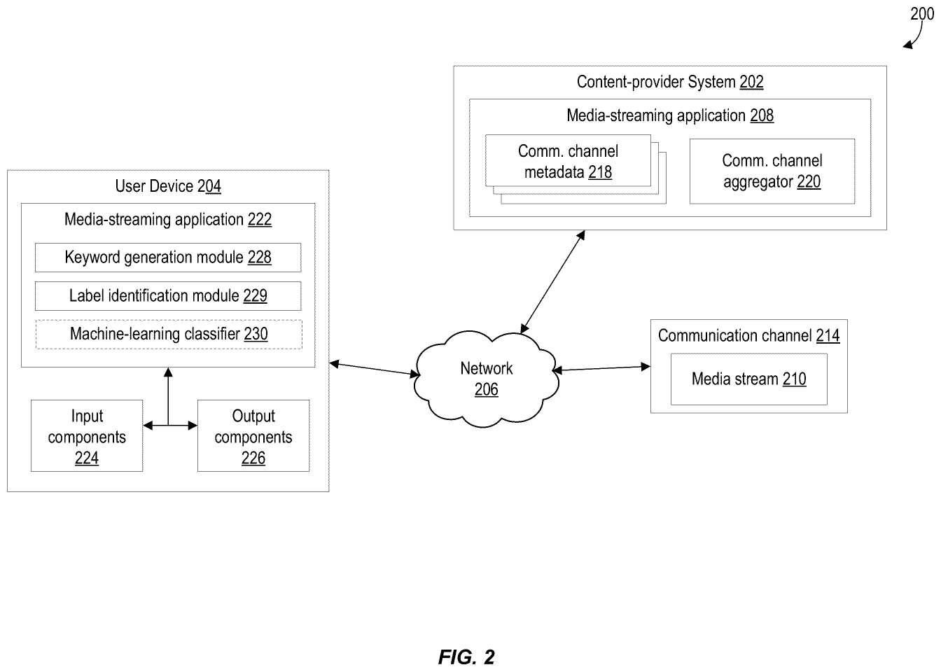

FIG. 2 illustrates an example computing environment for identifying context within media streams using machine-learning techniques, according to aspects of the present disclosure. A content-provider system 202 may include hardware and/or software components that operate within a distributed environment to stream media content to one or more user devices (e.g., a user device 204, etc.) over a communication network 206. The content-provider system 202 can store and execute a server-side media-streaming application 208, which may be configured to stream media stream 210 broadcasted from various communication channels (e.g., communication channel 214). To facilitate streaming of media content, the server-side media-streaming application 208 can access various data from the user device 204 (e.g., a computing device, an in-vehicle entertainment system, a mobile device, or the like). For example, the media-streaming application 208 can access past browsing history (e.g., web-browsing history, media-streaming application browsing history, historical communication channels accessed by the media streaming application, etc.) of the user device 204 and user profile data of the user device 204 to identify a set of default communication channels for streaming media content to the user device 204. In some instances, when operating in a distributed environment, the content-provider system 202 may include executable processes in which some processes may be executed by the user device 204 and some processes may be executed by the content-provider system 202.

The media-streaming application 208 may receive media streams corresponding to communication channel 214 (e.g., such, but not limited to a radio broadcast) over the network 206 (e.g., a cloud network, a local area network, a wide area network, the Internet, etc.). The media-streaming application 208 can process the media streams to present the corresponding media content to the user device 204. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 202 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 208. The content-provider system 202 can also include one or more databases that store communication channel metadata 218 that include data for identifying media content broadcasted by a communication channel, a genre of the media content, a program schedule of content included in the media content, location of the communication channel, and/or the like.

In some instances, a communication channel aggregator 220 may store an identification of groups of communication channels that share one or more common characteristics (e.g., such as, but not limited to, a location; a media presentation schedule; particular media presented such as songs, videos, talk radio or the like, genres, sports games; genre, media type, communication medium such as radio or Internet, etc.). For example, the communication channel aggregator 220 stores an identification of a first group of communication channels that provide sports-news content, an identification of a second group of communication channels that provide classical-rock content, and the like. As the user device 204 selects a particular communication channel provided by the media-streaming application 208, a corresponding group of communication channels may be presented together to allow the user to switch between different communication channels that may be similar. The particular common characteristics that determine an association between communication channels can be predetermined by the content provider, based on historical data, based on users that utilize the media-streaming application, based on locations at which the communication channels are broadcasted, etc. In some instances, the characteristics corresponding to a communication channel may be identified by analyzing the respective metadata of a communication channel or a media stream presented by the communication channel. For example, the metadata from a particular media stream can identify that the communication channel is a classical music radio station based in San Francisco, which can be grouped with a communication channel in New York that broadcasts classical music.

The user device 204 can also include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 202 and present the media stream through an interface of the user device 204 (e.g., a speaker, a display device, a wireless device connected to user device 204, etc.). As an illustrative example, the media-streaming application 222 can be installed in the user device, in which the media-streaming application 222 provides an interface that facilitates streaming of music broadcasted by a classical music radio station in New York. The media-streaming application 222 can access a media stream 210 of communication channel 214 as the music is being broadcasted from the communication channel 214 to the user device 204. The user device 204 also include a client-side media-streaming application 222, input components 224, and output components 226. The media-streaming application 222 can be configured to identify contextual information pertaining to output from one or more communication channels and providing recommended communication channels to the user device 204 in response to a user query. To enable user interaction with the media-streaming application 222, including the user query, the input components 224 can be utilized, which can include a microphone for speech, a touch-sensitive screen for gesture or graphical input, keyboard, mouse, motion input, pen, and other such input devices. In addition, the media content from the communication channel can be output using the output components 226, which can include, but not limited to, monitors, speakers, printers, haptic devices, and other such output devices.

In some instances, the user device 204 interacts with the media-streaming application 222 through a user interface to identify communication channels and access their respective media streams. The user interface may display one or more user interface elements that identify the media content presented, being presented, and/or to be presented by the user device (e.g., media stream 210), as well as the communication channel corresponding to the media content (e.g., communication channel 214). User input may be received using the input components 224 to select an icon that represents a communication channel, which triggers the media content to be presented on the user device 204 via the output components 226 (e.g., speaker, display screen).

The media-streaming application 222 can include a keyword generation module 228, a label identification module 229, and a machine-learning classifier 230, which can be used individually or in combination to identify context of media streams associated with communication channels. A media stream associated with a communication channel may be currently transmitted by the communication channel and may be received by the media-streaming application 222 in real-time. The media stream may include data associated with audio content. The media stream can additionally include other types of data (e.g., video, images, metadata, etc.). For example, the media stream can include metadata for use in identifying the media content of media stream 210 and/or the communication channel 214. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a communication channel (e.g., radio station), a location (e.g., a country, a state, a region, a city, an address, etc.), a context (e.g., such as a concept, emotion, an experience, and/or the like), or the like.

The keyword generation module 228 may access the metadata associated with the media stream and/or may access the machine-learning classifier 230 to generate one or more keywords associated with the media stream. For example, the keyword generation module 228 may receive media stream 210 of the communication channel 214 and access metadata associated with media stream 210 and/or may access the machine-learning classifier 230. The machine-learning classifier 230 may employ one or more machine-learning models to identify one or more keywords that describe the media stream 210. The one or more machine-learning models may use natural language processing, spectral analysis, and/or any other machine-learning processing method for analyzing audio input. For example, the one or more keywords may pertain to the genre, category, artist, host, team, type of news, any combination thereof, or the like. The one or more keywords may be stored in associated with the communication channel 214 in a database accessible by the media-streaming application 222 (e.g., the keywords database 116 described in FIG. 1).

The keyword generation module 228 may generate one or more keywords associated with a media stream of a communication channel. For example, the keyword generation module 228 may generate one or more keywords that pertain to the media stream 210 associated with the communication channel 214. The keyword generation module 228 may comprise one or more processors capable of generating the one or more keywords according to the media stream 210 and/or associated metadata stored in communication channel metadata 218. In some examples, the keyword generation module 228 may receive from the communication channel 214, a programming schedule, a media stream description, and/or any other information that may describe the current media stream associated with the communication channel 214. The keyword generation module 228 may utilize the data received from the communication channel 214 to generate the one or more keywords.

In some instances, the keyword generation module 228 can generate the one or more keywords using a machine-learning classifier 230. The machine-learning classifier 230 may receive the set of data and may be trained to generate one or more keywords pertaining to a media stream of a communication channel. Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. In some instances, the machine-learning model was trained using training data received and/or derived from media streams previously presented by the user device 204. In some examples, the machine-learning model was trained using training data received and/or derived from prior one or more keywords associated with a communication channel. In some instances, the machine-learning model was trained using media streams associated other user devices (e.g., such as other devices executing the media-streaming application). The machine-learning model can be trained using supervised training, supervised training, semi-supervised training, reinforcement training, combinations thereof, or the like.

For example, the machine-learning model may be trained using transfer learning. Transfer learning is a technique in machine learning where a machine-learning model initially trained to solve a particular task is used as the starting point for a different task. Transfer learning can be useful when the second task is somewhat similar to the first task, or when there is limited training data available for the second task. For example, a machine-learning model initially trained to make inferences regarding media content of a communication channel may be trained to generate one or more keywords pertaining to the media content of the communication channel. In some instances, the machine-learning classifier 230 accesses a pre-trained model and “fine-tunes” the pre-trained model by training it on a second training dataset. The second training dataset can include training data that are labeled as either corresponding to musical content or non-musical content (e.g., talk radio). To further fine-tune the machine-learning model, the machine-learning classifier 230 reconfigures the machine-learning model to include additional hidden and/or output layers to recognize musical and/or non-musical content and adapting the content of the one or more keywords (e.g., identifying the artist, album, and song title as the one or more keywords for musical content and identifying the topic, hosts, and genre of non-musical content). In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the machine-learning model can include freezing the weights of the machine-learning model, to train the machine-learning model generate one or more keywords. Then, the weights can be unfrozen such that the machine-learning model can be trained to improve accuracy of the one or more keywords.

The machine-learning classifier 230 may train the machine-learning model to identify a label for a media stream in conjunction with the label identification module 229. In some examples, the machine-learning model may also be configured to identify a duration of time for a timer. The timer may be used to determine how frequently the one or more keywords are removed and replaced by newly-generated one or more keywords for a particular communication channel. For example, the machine-learning model may identify that the media stream 210 is a soccer game, so the machine-learning model may define the duration of time associated with the communication channel 214 to be 45 minutes (the length of a half for a professional soccer game). After 45 minutes, the label identification module 229 may send a notification to the keyword generation module 228 to generate a new set of one or more keywords associated with the communication channel 214.

The media-streaming application 222 may receive input, via input components 224, from the user device 204. The input may be a search query comprising one or more search terms. In some examples, the search query may not be received from the user device 204, and may instead be generated by the machine-learning classifier 230 based on requested data, which may include, but is not limited to, data associated with a user profile of the user device 204 (e.g., listening history, demographics, geographic location, etc.), data associated with one or more similarly-situated user profiles of the user profile of the user device 204 (e.g., user profiles associated with the same demographic, geographic location, preferences, etc.), one or more keywords stored within media-streaming application 222 that meet a threshold frequency (e.g., identifying “trending” or “popular” topics), any combination thereof, or the like. The media-streaming application 222 may identify one or more communication channels associated with one or more keywords that are substantially similar to the search query. The media-streaming application 222 may utilize Boolean logic, neural networks, look-up tables, decision trees, machine-learning, and/or any other methods of defining a degree of similarity between the search query and keywords. In some examples, the one or more keywords may be associated with a hierarchy based on specificity (e.g., keywords that are more specific, such as a title, may be weighted higher than keywords that are less specific, such as genre or location) and/or the user data from the user that provided the query (e.g., historical searches, historical communication channels selected, etc.). The hierarchy (and/or user data) may be used to assign a weight to keywords that may be used to determine a degree of similarity between a query and communication channel. For example, the media-streaming application 222 may assign a score to each identified communication channel that at least partially matches the query based on the portion of the query and/or search terms that correspond to an identified keyword (e.g., a degree of matching) and the assigned weights of identified keywords. The media-streaming application 222 may present the communication channels with the highest score. Alternatively, the media-streaming application 222 may execute a machine-learning model using the query as an input feature vector. The machine-learning model may be configured to output an identification of one or more communication channels that correspond to the query. In some examples, the machine-learning classifier 230 may configure one or more machine-learning models trained to identify similar content according to context. For example, the one or more machine-learning models may identify that one or more keywords (e.g., “World Cup Final”) associated with a communication channel and the one or more search terms (e.g., “Final de la Copa Mundial,” which reads “World Cup Final” in Spanish) are referring to the same soccer game, even though the terms are not a match.

In some examples, the media-streaming application 222 may present, via the user device 204, the substantially similar one or more communication channels to the user as recommended communication channels. An indication of the recommended communication channels may be represented via a list, a graphic, a map, a wheel, overlay display, pop-up, grid, any combination thereof, or the like. The user device 204 may receive additional input indicating a selected communication channel. The media-streaming application 222 may initiate transmission of the selection communication channel via one or more output components 226 (e.g., a speaker). In some examples, the user device 204 may receive a second search query and the aforementioned process may be repeated for the second search query.

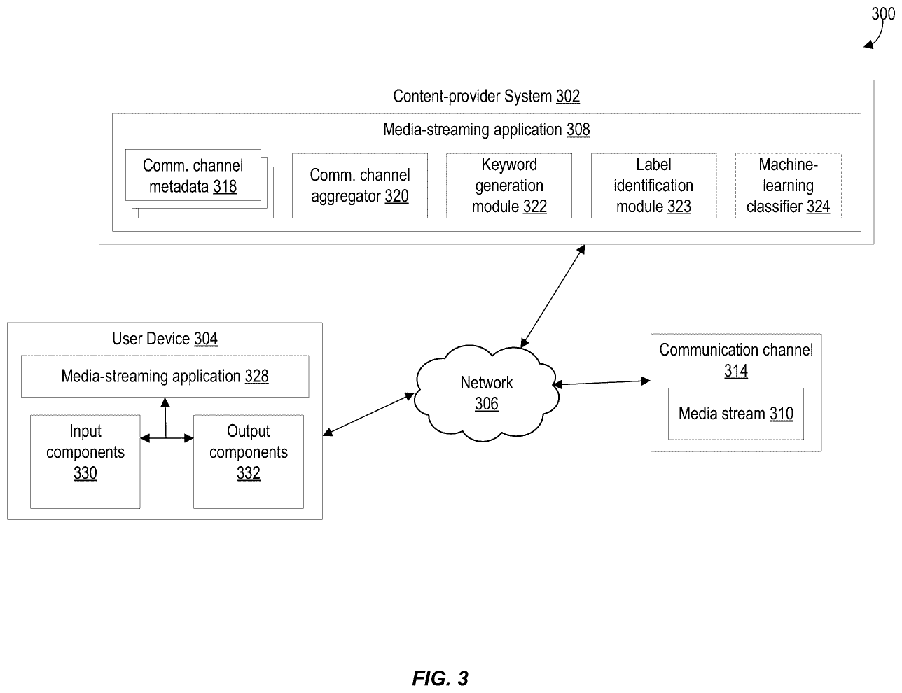

FIG. 3 illustrates an example computing environment for a content-provider system identifying context within media streams using machine-learning techniques, according to aspects of the present disclosure. A content-provider system 302 may include hardware and/or software components that operate within a distributed environment to stream media content to one or more user devices (e.g., a user device 304, etc.) over a communication network 306. The content-provider system 202 can store and execute a server-side media-streaming application 308, which may be configured to stream media stream 310 broadcasted from various communication channels (e.g., communication channels 214). To facilitate streaming of media content, the server-side media-streaming application 308 can access various data from the user device 304 (e.g., a computing device, an in-vehicle entertainment system, a mobile device, or the like). For example, the media-streaming application 308 can access past browsing history (e.g., web-browsing history, media-streaming application browsing history, historical communication channels accessed by the media streaming application, etc.) of the user device 304 and user profile data of the user device 304 to identify a set of default communication channels for streaming media content to the user device 304. In some instances, when operating in a distributed environment, the content-provider system 302 may include executable processes in which some processes may be executed by the user device 304 and some processes may be executed by the content-provider system 302.

The media-streaming application 308 may receive media streams corresponding to the media stream 310 (e.g., such, but not limited to a radio broadcast) over the network 306 (e.g., a cloud network, a local area network, a wide area network, the Internet, etc.). The media-streaming application 308 can process the media streams to present the corresponding media content to the user device 304. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 302 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 308. The content-provider system 302 can also include one or more databases that store communication channel metadata 318 that include data for identifying media content broadcasted by a communication channel, a genre of the media content, a program schedule of content included in the media content, location of the communication channel, and/or the like.

In some instances, a communication channel aggregator 320 may store an identification of groups of communication channels that share one or more common characteristics (e.g., such as, but not limited to, a location; a media presentation schedule; particular media presented such as songs, videos, talk radio or the like, genres, sports games; genre, media type, communication medium such as radio or Internet, etc.). For example, the communication channel aggregator 320 stores an identification of a first group of communication channels that provide sports-news content, an identification of a second group of communication channels that provide classical-rock content, and the like. As the user device 304 selects a particular communication channel provided by the media-streaming application 308, a corresponding group of communication channels may be presented together to allow the user to switch between different communication channels that may be similar. The particular common characteristics that determine an association between communication channels can be predetermined by the content provider based on historical data, based on users that utilize the media-streaming application, based on locations at which the communication channels are broadcasted, etc. In some instances, the characteristics corresponding to a communication channel may be identified by analyzing the respective metadata a communication channel or a media stream presented by the communication channel. For example, the metadata from a particular media stream can identify that the communication channel is a classical music radio station based in San Francisco, which can be grouped with a communication channel in New York that broadcasts classical music.

In addition, the media-streaming application 308 can include a keyword generation module 322, a label identification module 323, and a machine-learning classifier 324, which can be used individually or in combination to identify context of media streams associated with communication channels. A media stream associated with a communication channel may be currently transmitted by the communication channel and may be received by the media-streaming application 308 in real-time. The media stream may include data associated with audio content. The media stream can additionally include other types of data (e.g., video, images, metadata, etc.). For example, the media stream can include metadata for use in identifying the media content of media stream 310 and/or the communication channel 314. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a communication channel (e.g., radio station), a location (e.g., a country, a state, a region, a city, an address, etc.), a context (e.g., such as a concept, emotion, an experience, and/or the like), or the like.

The keyword generation module 322 may access the metadata associated with the media stream 310 and/or may access the machine-learning classifier 324 to generate one or more keywords associated with the media stream. For example, the keyword generation module 322 may receive media stream 310 of the communication channel 314 and access metadata associated with media stream 310 and/or may access the machine-learning classifier 324. The machine-learning classifier 324 may employ one or more machine-learning models to identify one or more keywords that describe the media stream 310. The one or more machine-learning models may use natural language processing, spectral analysis, and/or any other machine-learning processing method for analyzing audio input. For example, the one or more keywords may pertain to the genre, category, artist, host, team, type of news, any combination thereof, or the like. The one or more keywords may be stored in associated with the communication channel 314 in a database accessible by the media-streaming application 308 (e.g., the keywords database 116 described in FIG. 1). The media stream may be audio and/or visual content. A media-streaming application 328 can be installed in the user device 304, in which the media-streaming application 328 provides an interface that facilitates streaming of the media stream 310 broadcasted by the communication channel 314. The media-streaming application 308 can access the media stream as the content is being broadcasted from the communication channel 314 to the user device 304.

The keyword generation module 322 may generate one or more keywords associated with a media stream of a communication channel. For example, the keyword generation module 322 may generate one or more keywords that pertain to the media stream 310 associated with the communication channel 314. The keyword generation module 322 may comprise one or more processors capable of generating the one or more keywords according to the media stream 310 and/or associated metadata stored in communication channel metadata 318. In some examples, the keyword generation module 322 may receive from the communication channel 314, a programming schedule, a media stream description, and/or any other information that may describe the current media stream associated with the communication channel 314. The keyword generation module 322 may utilize the data received from the communication channel 314 to generate the one or more keywords.

In some instances, the keyword generation module 322 can generate the one or more keywords using a machine-learning classifier 324. The machine-learning classifier 324 may receive the set of data and may be trained to generate one or more keywords pertaining to a media stream of a communication channel. Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. In some instances, the machine-learning model was trained using training data received and/or derived from media streams previously presented by the user device 304. In some examples, the machine-learning model was trained using training data received and/or derived from prior one or more keywords associated with a communication channel. In some instances, the machine-learning model was trained using media streams associated other user devices (e.g., such as other devices executing the media-streaming application). The machine-learning model can be trained using supervised training, supervised training, semi-supervised training, reinforcement training, combinations thereof, or the like.

For example, the machine-learning model may be trained using transfer learning. Transfer learning is a technique in machine learning where a machine-learning model initially trained to solve a particular task is used as the starting point for a different task. Transfer learning can be useful when the second task is somewhat similar to the first task, or when there is limited training data available for the second task. For example, a machine-learning model initially trained to make inferences regarding media content of a communication channel may be trained to generate one or more keywords pertaining to the media content of the communication channel. In some instances, the machine-learning classifier 324 accesses a pre-trained model and “fine-tunes” the pre-trained model by training it on a second training dataset. The second training dataset can include training data that are labeled as either corresponding to musical content or non-musical content (e.g., talk radio). To further fine-tune the machine-learning model, the machine-learning classifier 324 reconfigures the machine-learning model to include additional hidden and/or output layers to recognize musical and/or non-musical content and adapting the content of the one or more keywords (e.g., identifying the artist, album, and song title as the one or more keywords for musical content and identifying the topic, hosts, and genre of non-musical content). In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the machine-learning model can include freezing the weights of the machine-learning model, to train the machine-learning model generate one or more keywords. Then, the weights can be unfrozen such that the machine-learning model can be trained to improve accuracy of the one or more keywords.

The machine-learning classifier 324 may train the machine-learning model to identify a label for a media stream in conjunction with the label identification module 323. In some examples, the machine-learning model may also be configured to identify a duration of time for a timer. The timer may be used to determine how frequently the one or more keywords are removed and replaced by newly-generated one or more keywords for a particular communication channel. For example, the machine-learning model may identify that the media stream 310 is a soccer game, so the machine-learning model may define the duration of time associated with the communication channel 314 to be 45 minutes (the length of a half for a professional soccer game). After 45 minutes, the label identification module 323 may send a notification to the keyword generation module 322 to generate a new set of one or more keywords associated with the communication channel 314.

The user device 304 can include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 302 and present the media stream through an interface of the user device 304 (e.g., a speaker, a display device, a wireless device connected to user device 304, etc.). The user device 304 also include a client-side media-streaming application 328, input components 330, and output components 332. The media-streaming application 328 can receive media streams transmitted by the content-provider system 302 and present media content from various communication channels. In some instances, the media-streaming application 328 can be configured to identify contextual information pertaining to output from one or more communication channels and providing recommended communication channels to the user device 304 in response to a user query.

To enable user interaction with the media-streaming application 328, the input components 330 can be utilized, which can include a microphone for speech, a touch-sensitive screen for gesture or graphical input, keyboard, mouse, motion input, pen, and other such input devices. In addition, the media content from the communication channel can be output using the output components 332, which can include, but not limited to, monitors, speakers, printers, haptic devices, and other such output devices. In some instances, the user device 304 interacts with the media-streaming application 328 through a user interface to identify communication channels and access their respective media streams. The user interface may display one or more user interface elements that identify the media content presented, being presented, and/or to be presented by the user device (e.g., the media stream 310), as well as the communication channel corresponding to the media content (e.g., the communication channel 314). The user input may be received using the input components 224 to select an icon that represents a communication channel, which triggers the media content to be presented on the user device 304 via the output components 326 (e.g., speaker, display screen).

The media-streaming application 328 may receive input, via input components 330, from the user device 304. The input may be a search query comprising one or more search terms. In some examples, the search query may not be received from the user device 304, and may instead be generated by the machine-learning classifier 324 based on requested data, which may include, but is not limited to, data associated with a user profile of the user device 304 (e.g., listening history, demographics, geographic location, etc.), data associated with one or more similarly-situated user profiles of the user profile of the user device 304 (e.g., user profiles of the same demographic, geographic location, preferences, etc.), one or more keywords stored within media-streaming application 308 that meet a threshold frequency (e.g., identifying “trending” or “popular” topics), any combination thereof, or the like. The media-streaming application 328 may transmit the search query, via the network 306, to the media-streaming application 308. The media-streaming application 308 may identify one or more communication channels associated with one or more keywords that are substantially similar to the search query. The media-streaming application 328 may utilize Boolean logic, neural networks, look-up tables, decision trees, machine-learning, and/or any other methods of defining a degree of similarity between the search query and keywords. In some examples, the one or more keywords may be associated with a hierarchy based on specificity (e.g., keywords that are more specific, such as a title, may be weighted higher than keywords that are less specific, such as a genre or location) and/or the user data from the user that provided the query (e.g., historical searches, historical communication channels selected, etc.). The hierarchy (and/or user data) may be used to assign a weight to keywords that may be used to determine a degree of similarity between a query and a communication channel. For example, the media-streaming application 308 may assign a score to each identified communication channel that at least partially matches the query based on the portion of the query and/or search terms that correspond to an identified keyword (e.g., a degree of matching) and the assigned weights of identified keywords. The media-streaming application 308 may transmit the communication channels with the highest score to media-streaming application 328 via the network 306, and the media-streaming application 328 may present the communication channels with the highest score. Alternatively, the media-streaming application 308 may execute a machine-learning model using the query as an input feature vector. The machine-learning model may be configured to output an identification of one or more communication channels that correspond to the query. In some examples, the machine-learning classifier 324 may configure one or more machine-learning models trained to identify similar content according to context. For example, the one or more machine-learning models may identify that one or more keywords (e.g., “World Cup Final”) associated with a communication channel and the one or more search terms (e.g., “Final de la Copa Mundial,” which reads “World Cup Final” in Spanish) are referring to the same soccer game, even though the terms are not a match. The media-streaming application 308 may transmit a substantially similar one or more communication channels to the media-streaming application 328 via the network 306.

In some examples, the media-streaming application 328 may present, via the user device 304, the substantially similar one or more communication channels to the user as recommended communication channels. An indication of the recommended communication channels may be represented via a list, a graphic, a map, a wheel, overlay display, pop-up, grid, any combination thereof, or the like. The user device 304 may receive additional input indicating a selected communication channel. The media-streaming application 328 may initiate transmission of the selection communication channel via one or more output components 332 (e.g., a speaker). In some examples, the user device 304 may receive a second search query and the aforementioned process may be repeated for the second search query.

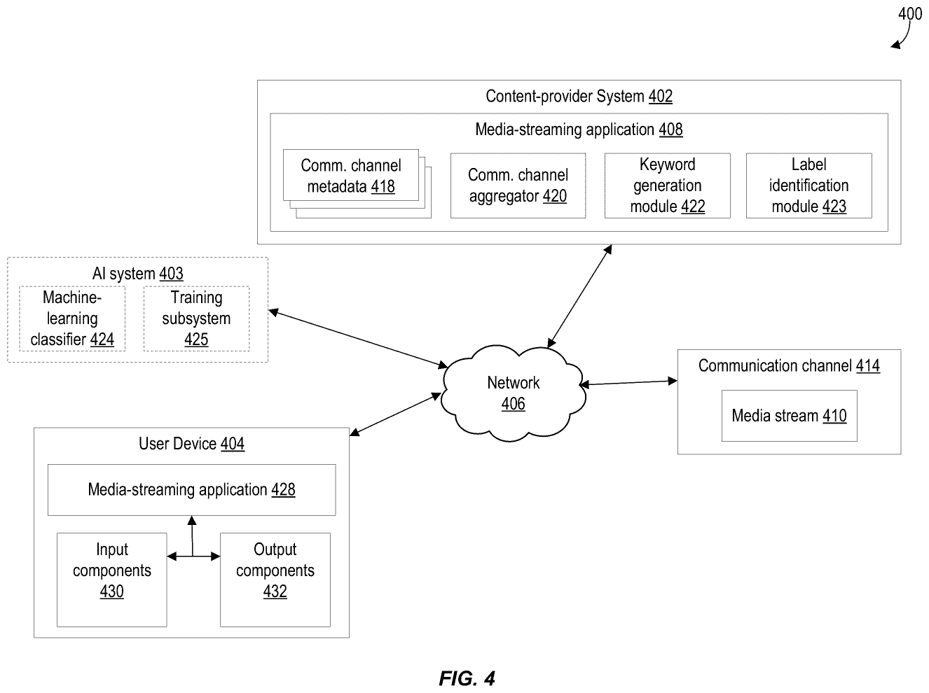

FIG. 4 illustrates an example computing environment for a content-provider system identifying context within media streams based on output generated from a special-purpose computer, according to aspects of the present disclosure. A content-provider system 402 may include hardware and/or software components that operate within a distributed environment to stream media content to one or more user devices (e.g., a user device 404, etc.) over a communication network 406. The content-provider system 402 can store and execute a server-side media-streaming application 408, which may be configured to stream media stream 410 broadcasted from various communication channels (e.g., communication channel 414). To facilitate streaming of media content, the server-side media-streaming application 408 can access various data from the user device 404 (e.g., a computing device, an in-vehicle entertainment system, a mobile device, or the like). For example, the media-streaming application 408 can access past browsing history (e.g., web-browsing history, media-streaming application browsing history, historical communication channels accessed by the media streaming application, etc.) of the user device 404 and user profile data of the user device 404 to identify a set of default communication channels for streaming media content to the user device 404. In some instances, when operating in a distributed environment, the content-provider system 402 may include executable processes in which some processes may be executed by the user device 404 and some processes may be executed by the content-provider system 402.

The media-streaming application 408 may receive media streams corresponding to the media stream 410 (e.g., such as, but not limited to a radio broadcast) over the network 406 (e.g., a cloud network, a local area network, a wide area network, the Internet, etc.). The media-streaming application 408 can process the media stream to present the corresponding media content to the user device 404. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 402 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 408. The content-provider system 402 can also include one or more database that store communication channel metadata 418 that include data for identifying media content broadcasted by a communication channel, a genre of the media content, a program schedule of content included in the media content, location of the communication channel, and/or the like.

In some instances, a communication channel aggregator 420 may store an identification of groups of communication channels that share one or more common characteristics (e.g., such as, but not limited to, a location; a media-presentation schedule; particular media presented, such as songs, videos, talk radio or the like, genres, sports games; genre, media type, communication medium such as radio or Internet, etc.). For example, the communication channel aggregator 420 stores an identification of a first group of communication channels that provide sports-news content, an identification of a second group of communication channels that provide classical-rock content, and the like. As the user device 404 selects a particular music source provided by the media-streaming application 408, a corresponding group of communication channels may be presented together to allow the user to switch between different communication channels that may be similar. The particular common characteristics that determine an association between communications channels can be predetermined by the content provider, based on historical data, based on users that utilize the media-streaming application, based on locations at which the communication channels are broadcasted, etc. In some instances, the characteristics corresponding to a communication channel may be identified by analyzing the respective metadata of a communication channel or a media stream presented by the communication channel.

In addition, the media-streaming application 408 of the content-provider system 402 can include a keyword generation module 422 and a label identification module 423, which can be used individually or in combination to identify context of media streams associated with communication channels. A media stream associated with a communication channel may be currently transmitted by the communication channel and may be received by the media-streaming application 408 in real-time. The media stream may include data associated with audio content. The media stream can additionally include other types of data (e.g., video, images, metadata, etc.). For example, the media stream can include metadata for use in identifying the media content of the media stream 410 and/or the communication channel 414. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a communication channel (e.g., a radio station), a location (e.g., a country, a state, a region, a city, an address, etc.), a context (e.g., such as a concept, emotion, an experience, and/or the like), or the like.

The label identification module 423 may access the metadata associated with the media stream and may notify the keyword generation module 422 to generate one or more keywords associated with the media stream 410 of the communication channel 414. For example, the one or more keywords may pertain to the genre, category, artist, host, team, type of news, any combination thereof, or the like. The one or more keywords may be stored in associated with the communication channel 414 in a database accessible by the media-streaming application 408 (e.g., the keywords database 116 described in FIG. 1). The media stream may be audio and/or visual content. A media-streaming application 428 can be installed in the user device 404, in which the media-streaming application 428 provides an interface that facilitates streaming of the media stream 410 broadcasted by the communication channel 414. The media-streaming application 408 can access the media stream of media stream 410 as the music is being broadcasted from the communication channel 414 to the user device 404.

The keyword generation module 422 may generate one or more keywords associated with a media stream of a communication channel. For example, the keyword generation module 422 may generate one or more keywords that pertain to the media stream 410 associated with the communication channel 414. The keyword generation module 422 may comprise one or more processors capable of generating the one or more keywords according to the media stream 410 and/or associated metadata stored in communication channel metadata 418. In some examples, the keyword generation module 422 may receive from the communication channel 414, a programming schedule, a media stream description, and/or any other information that may describe the current media stream associated with the communication channel 414. The keyword generation module 422 may utilize the data received from the communication channel 414 to generate the one or more keywords.

In some instances, the keyword generation module 422 can interact with the AI system 403 to generate the one or more keywords. In some embodiments, the AI system 403 is implemented by a special purpose computer that is specifically trained to generate one or more keywords pertaining to a current media stream of a communication channel. For example, the AI system 403 may receive media stream 410 of the communication channel 414 and may use one or more machine-learning models to generate one or more keywords associated with the current media stream. The one or more machine-learning models may use natural language processing, spectral analysis, and/or any other machine-learning processing method of analyzing audio input. Additionally, one or more components of the AI system 403 is implemented by another special purpose computer (e.g., a training subsystem 425) that is specifically configured to train the machine-learning model using an amount of historical data and applying the trained machine-learning algorithms to generate one or more keywords pertaining to a media stream of a communication channel. The AI system 403 may receive a set of data and may train the machine-learning model to generate the one or more keywords.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. The training subsystem 425 of the AI system can be configured to train the machine-learning model using training data received and/or derived from media streams previously presented by the user device 404. In some instances, the training subsystem 425 trains the machine-learning model using media streams associated other user devices (e.g., such as other devices executing the media-streaming application). The training subsystem 425 can train the machine-learning model using supervised training, supervised training, semi-supervised training, reinforcement training, combinations thereof, or the like.

For example, the training subsystem 425 may train the machine-learning model using transfer learning. Transfer learning is a technique in machine learning where a machine-learning model initially trained by the training subsystem 425 to solve a particular task is used as the starting point for a different task. Transfer learning can be useful when the second task is somewhat similar to the first task, or when there is limited training data available for the second task. For example, a machine-learning model initially trained to generate a list of similar communication channels may be further trained to generate a list of communication channels customized for a particular user device. In some instances, the machine-learning classifier 230 accesses a pre-trained model and “fine-tunes” the pre-trained model by training it on a second training dataset. The second training dataset can include training data that are labeled as either corresponding to musical content or non-musical content (e.g., talk radio). To further fine-tune the machine-learning model, the machine-learning classifier 424 reconfigures the machine-learning model to include additional hidden and/or output layers to recognize musical and/or non-musical content and dynamically adapting the timer 434 (e.g., identifying the artist, album, and song title as the one or more keywords for musical content and identifying the topic, hosts, and genre of non-musical content). In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the machine-learning model can include freezing the weights of the machine-learning model, to train the machine-learning model to generate one or more keywords. Then, the weights can be unfrozen such that the machine-learning model can be trained to improve accuracy of the one or more keywords.

The machine-learning classifier 424 may train the machine-learning model to identify a label for a media stream in conjunction with the label identification module 423. In some examples, the machine-learning model may also be configured to identify a duration of time for a timer. The timer may be used to determine how frequently the one or more keywords are removed and replaced by newly-generated one or more keywords for a particular communication channel. For example, the machine-learning model may identify that the media stream 410 is a soccer game, so the machine-learning model may define the duration of time associated with the communication channel 414 to be 45 minutes (the length of a half for a professional soccer game). After 45 minutes, the label identification module 423 may send a notification to the keyword generation module 422 to generate a new set of one or more keywords associated with the communication channel 414.

The user device 404 can include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 402 and present the media stream through an interface of the user device 404 (e.g., a speaker, a display device, a wireless device connected to user device 404, etc.). The user device 404 also include a client-side media-streaming application 428, input components 430, and output components 432. The media-streaming application 428 can be receive media stream transmitted by the content-provider system 402 and present media content from various communication channels. In some instances, the media-streaming application 428 can be configured to identify contextual information pertaining to output from one or more communication channels and providing recommended communication channels to the user device 404 in response to a user query.

To enable user interaction with the media-streaming application 428, the input components 430 can be utilized, which can include a microphone for speech, a touch-sensitive screen for gesture or graphical input, keyboard, mouse, motion input, pen, and other such input devices. In addition, the media content from the communication channel can be outputted using the output components 432, which can include, but not limited to, monitors, speakers, printers, haptic devices, and other such output devices. In some instances, the user device 404 interacts with the media-streaming application 428 through a user interface to identify communication channels and access their respective media streams. The user interface may display one or more user interface elements that identify the media content presented, being presented, and/or to be presented by the user device (e.g., the media stream 410), as well as the communication channel corresponding to the media content (e.g., the communication channel 414). The user input may be received using the input components 430 to select an icon that represents a communication channel, which triggers the media content to be presented on the user device 404 via the output components 426 (e.g., speaker, display screen).

The media-streaming application 428 may receive input, via input components 430, from the user device 404. The input may be a search query comprising one or more search terms. In some examples, the search query may not be received from the user device 404, and may instead be generated by the machine-learning classifier 424 based on requested data, which may include, but is not limited to, data associated with a user profile of the user device 404 (e.g., listening history, demographics, geographic location, etc.), data associated with one or more similarly-situated user profiles of the user profile of the user device 404 (e.g., user profiles associated with the same demographic, geographic location, preferences, etc.), one or more keywords stored within media-streaming application 408 that meet a threshold frequency (e.g., identifying “trending” or “popular” topics), any combination thereof, or the like. The media-streaming application 428 may transmit the search query, via the network 406, to the media-streaming application 408. The media-streaming application 408 may identify one or more communication channels associated with one or more keywords that are substantially similar to the search query. The media-streaming application 428 may utilize Boolean logic, neural networks, look-up tables, decision trees, machine-learning, and/or any other methods of defining a degree of similarity between the search query and keywords. In some examples, the one or more keywords may be associated with a hierarchy based on specificity (e.g., keywords that are more specific, such as a title, may be weighted higher than keywords that are less specific, such as a genre or location) and/or the user data from the user that provided the query (e.g., historical searches, historical communication channels selected, etc.). The hierarchy (and/or user data) may be used to assign a weight to keywords that may be used to determine a degree of similarity between a query and a communication channel. For example, the media-streaming application 408 may assign a score to each identified communication channel that at least partially matches the query based on the portion of the query and/or search terms that correspond to an identified keyword (e.g., a degree of matching) and the assigned weights of identified keywords. The media-streaming application 408 may transmit the communication channels with the highest score to media-streaming application 428 via the network 406, and the media-streaming application 428 may present the communication channels with the highest score. Alternatively, the media-streaming application may request execution of a machine-learning model from AI system 403 using the query as an input feature vector. The machine-learning model may be configured to output an identification of one or more communication channels that correspond to the query. In some examples, the machine-learning classifier 424 may configure one or more machine-learning models trained to identify similar content according to context. For example, the one or more machine-learning models may identify that one or more keywords (e.g., “World Cup Final”) associated with a communication channel and the one or more search terms (e.g., “Final de la Copa Mundial,” which reads “World Cup Final” in Spanish) are referring to the same soccer game, even though the terms are not a match. The media-streaming application 408 may transmit a substantially similar one or more communication channels to the media-streaming application 428 via the network 406.

In some examples, the media-streaming application 428 may present, via the user device 404, the substantially similar one or more communication channels to the user as recommended communication channels. An indication of the recommended communication channels may be represented via a list, a graphic, a map, a wheel, overlay display, pop-up, grid, any combination thereof, or the like. The user device 404 may receive additional input indicating a selected communication channel. The media-streaming application 428 may initiate transmission of the selection communication channel via one or more output components 432 (e.g., a speaker). In some examples, the user device 404 may receive a second search query and the aforementioned process may be repeated for the second search query.

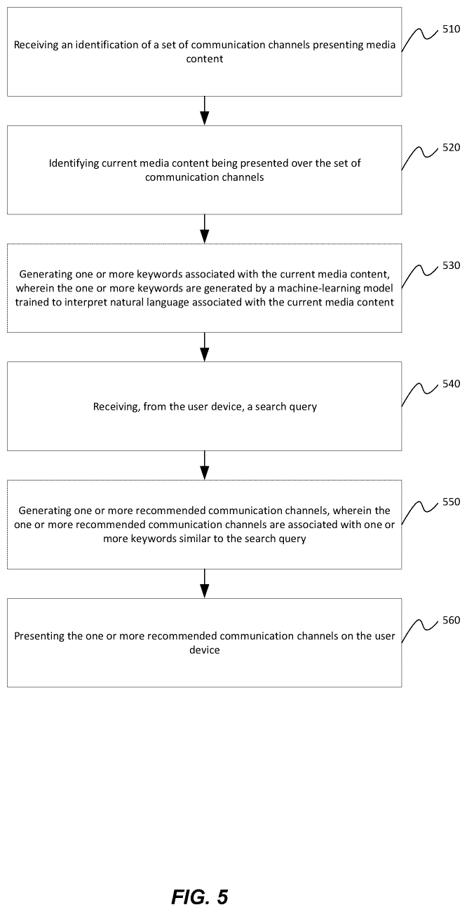

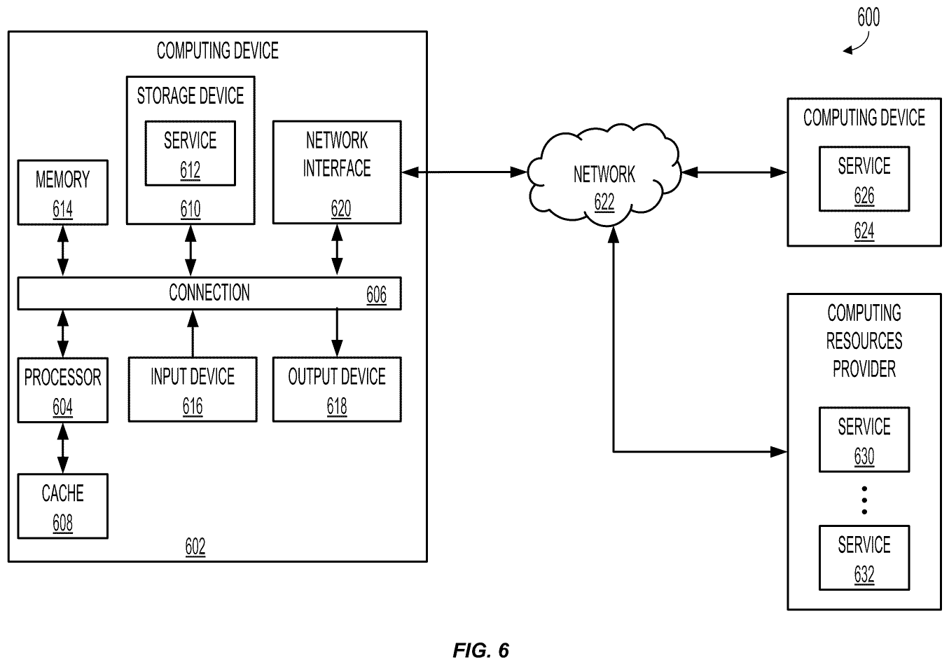

FIG. 5 illustrates an example process for identifying context within media streams using machine-learning techniques, according to some embodiments. For illustrative purposes, the process 500 is described with reference to the components illustrated in FIGS. 2-4, though other implementations are possible. For example, the program code for the media-streaming application of FIGS. 2-4, is executed by one or more processing devices to cause a server system (e.g., the computing device 602 of FIG. 6) to perform one or more operations described herein.

At block 510, a media-streaming system may receive an identification of a set of communication channels presenting media content. In some examples, the media-streaming system may be media-streaming application 222 of FIG. 2. The media-streaming system may be hosted on a user device (e.g., the user device 204 described in FIG. 2) or on an external system (e.g., content-provider system 202 described in FIG. 2). The media-streaming system may receive media streams corresponding to communication channels over a network (e.g., a cloud network, a local area network, a wide area network, the Internet, etc.). The media streams may be transmitted or broadcasted by the communication channels. The media-streaming system can process the media streams to present the corresponding media content to the user device. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

At block 520, the media-streaming system may identify current media content being presented over the set of communication channels. The media-streaming system can access a media stream of media content as the content is being broadcasted from the communication channel to a user device. The current media content may be the media content from the media stream received by the media-streaming application in real-time. The current media content may be a commercial, a song, a talk show, a sports game, or any other entertainment content. In some examples, the current media content may be analyzed by one or more machine-learning models. The one or more machine-learning models may be trained to interpret natural language, perform spectral analysis, trained to recognize types of media content, and/or any other type of machine-learning processing for audio input. For example, a first machine-learning model may receive the current media content and may identify the current media content as a song.

At block 530, the media-streaming system may generate one or more keywords associated with the current media content, where the one or more keywords are generated by a machine-learning model trained to interpret natural language associated with the current media content. The keyword generation module may use one or more processors to filter the data to determine elements of the data that are applicable to the current media content of a communication channel. The keyword generation module may generate, using the filtered data, one or more keywords applicable to the current media content. The keyword generation module may store the one or more keywords in a keywords database. The keywords database may be stored in a location accessible to the media-streaming application, including, but not limited to, local memory, cloud storage, external memory, any combination thereof, or the like. The keywords database may store the one or more keywords in associated with the media stream and/or the communication channel. For example, the keywords database may be formatted as a table, thereby enabling the one or more keywords to be associated with the media stream and/or the communication channel via rows or columns.

In some examples, the keyword generation module may generate the one or more keywords using a machine-learning classifier. The current media content may include a song, a talk show, a sports game, any combination thereof, or the like. The keyword generation module may transmit the media stream to a machine-learning classifier. The machine-learning classifier may enable one or more machine-learning models trained to interpret natural language, recognize patterns in audio data, audio recognition, any combination thereof, or the like. For example, a first machine-learning model may receive the media stream and may identify a song and artist associated with the media stream.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. In some instances, the machine-learning model was trained using training data received and/or derived from media streams previously presented by a user device. In some examples, the first machine-learning model was trained using training data received and/or derived from one or more keywords associated with one or more communication channels. In some instances, the first machine-learning model was trained using media streams associated with other user devices (e.g., such as other devices executing the media-streaming application). The first machine-learning model can be trained using supervised training, supervised training, semi-supervised training, reinforcement training, combinations thereof, or the like.

At block 540, the media-streaming system may receive, from a user device, a search query. The user device may query the media-streaming application using one or more search terms. The search terms may be comprised of a song, a genre, a topic, a region, a composer, an artist, an album, a sports team, any combination thereof, or the like. The media-streaming application may receive the one or more search terms from the user device.

At block 550, the media-streaming system may generate one or more recommended communication channels, wherein the one or more recommended communication channels are associated with one or more keywords similar to the search query. In some examples, the media-streaming application may translate the search query into one or more keywords and match the one or more keywords to keywords associated with communication channels. The one or more keywords may be weighted based on a degree of specificity (e.g., indication of the quantity of communication channels that are associated with a keyword, such that keywords associated with a fewer quantity of communication channels are considered more specific and are assigned a higher weight than keywords associated with a greater quantity of communication channels) and/or user data (e.g., historical queries executed by the user, communication channels selected from queries, etc.). The media-streaming application may generate a score for each communication channel based on the weights assigned to the portion of the one or more keywords that match keywords of a communication channel. The scores may be used to select communications to be included in the one or more recommended communication channels. Alternatively, the media-streaming application may use a machine-learning model to generate the one or more recommended communication channels using the query as an input feature vector. The machine-learning model may parse the query and output the one or more recommended communication channels.

As an illustrative example, the user device may transmit the query “Champions League final 2023” to the media-streaming application. The media-streaming application may query the keywords database for at least one set of one or more keywords that are substantially similar to “Champions League final 2023.” The media-streaming application may receive two sets of one or more keywords, “Champions League final Manchester City vs. Inter Milan Jun. 10, 2023” and “2023 UEFA Champions League Final.” The media-streaming application may query the keywords database for the two communication channels associated with the two sets of one or more keywords.

At block 560, the media-streaming system may present the one or more recommended communication channels on the user device. The media-streaming application may present one or more recommended communication channels to the user device. The media-streaming application may present an indication of the one or more recommended communication channels in the form of a list, graphic, a map, a wheel, overlay display, pop-up, grid, any combination thereof, or the like.

FIG. 6 illustrates a computing system architecture 600, including various components in electrical communication with each other, in accordance with some embodiments. The example computing system architecture 600 illustrated in FIG. 6 includes a computing device 602, which has various components in electrical communication with each other using a connection 606, such as a bus, in accordance with some implementations. The example computing system architecture 600 includes a processing unit 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system architecture 600 includes a cache 608 of high-speed memory connected directly with, in close proximity to, or integrated as part of the processor 604. The system architecture 600 can copy data from the memory 614 and/or the storage device 610 to the cache 608 for quick access by the processor 604. In this way, the cache 608 can provide a performance boost that decreases or eliminates processor delays in the processor 604 due to waiting for data. Using modules, methods, and services such as those described herein, the processor 604 can be configured to perform various actions. In some embodiments, the cache 608 may include multiple types of cache including, for example, level one (L1) and level two (L2) cache. The memory 614 may be referred to herein as system memory or computer system memory. The memory 614 may include, at various times, elements of an operating system, one or more applications, data associated with the operating system or the one or more applications, or other such data associated with the computing device 602.

Other system memory 614 can be available for use as well. The memory 614 can include multiple different types of memory with different performance characteristics. The processor 604 can include any general purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the attached input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system architecture 600, the storage device 610 can be connected to other parts of the computing device 602 using the system connection 606. In some embodiments, a hardware service or hardware module such as service 612, that performs a function can include a software component stored in a non-transitory computer-readable medium that, in connection with the necessary hardware components, such as the processor 604, connection 606, cache 608, storage device 610, memory 614, input device 616, output device 618, and so forth, can carry out the functions such as those described herein.

The disclosed systems and service of a media-streaming application (e.g., the media-streaming application 222 described herein at least in connection with FIG. 2) can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for generating proposals associated with a media-streaming application (e.g., the media-streaming application 222 described herein at least in connection with FIG. 2) described herein by, for example, executing code using a processor such as processor 604 wherein the code is stored in memory such as memory 614 as described herein. One or more of a user device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 614 can be coupled to the processor 604 by, for example, a connector such as connector 606, or a bus. As used herein, a connector or bus such as connector 606 is a communications system that transfers data between components within the computing device 602 and may, in some embodiments, be used to transfer data between computing devices. The connector 606 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 614 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connector 606 (or bus) can also couple the processor 604 to the storage device 610, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g., network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® ctc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a computer-implemented method, comprising: receiving an identification of a set of communication channels presenting media content; identifying current media content being presented over the set of communication channels; generating one or more keywords associated with the current media content, wherein the one or more keywords are generated by a machine-learning model trained to interpret natural language associated with the current media content; receiving, from the user device, a search query; generating one or more recommended communication channels, wherein the one or more recommended communication channels are associated with one or more associated keywords similar to the search query; and presenting the one or more recommended communication channels on the user device.

Example 2 is the computer-implemented method of example(s) 1, further comprising: generating, according to the one or more keywords, a label of communication channels, wherein the label of communication channels is associated with a duration of time; after the duration of time, identifying updated current media content being presented over the label of communication channels; and generating one or more updated keywords associated with the current media content.

Example 3 is the computer-implemented method of example(s) 1-2, further comprising: receiving, from the user device, feedback associated with the one or more recommended communication channels; and updating the machine-learning model according to the feedback.

Example 4 is the computer-implemented method of example(s) 1-3, wherein the one or more keywords are generated by receiving data from the set of communication channels.

Example 5 is the computer-implemented method of example(s) 1-4, wherein the one or more recommended communication channels are further generated based on user data, wherein user data includes at least a user profile associated with the user device.

Example 6 is the computer-implemented method of example(s) 1-5, wherein the machine-learning model was trained using transfer learning.

Example 7 is the computer-implemented method of example(s) 1-6, wherein the one or more keywords comprises at least one of a song title, a song categorization, a topic of discussion, a subject matter, names of one or more hosts, original broadcast location of a media source, or title of programming.

Example 8 is the computer-implemented method of example(s) 1-7, further comprising: generating one or more trending topics based on a popularity of keywords associated with the media content across multiple communication channels; and presenting the one or more trending topics on the user device to enable passive browsing of popular content.

Example 9 is the computer-implemented method of example(s) 1-8, wherein the one or more trending topics are dynamically updated based on real-time changes in media content across the set of communication channels.

Example 10 is the computer-implemented method of example(s) 1-9, further comprising: analyzing user interaction data across multiple users to identify common topics of interest associated with the media content; creating a personalized set of topics for a user based on similarity to identified topics of interest from other users; and presenting the personalized set of topics on the user device to facilitate browsing and discovery.

Example 11 is the computer-implemented method of example(s) 1-10, further comprising: generating one or more topic categories from keywords associated with the media content, wherein each category groups related topics together; enabling a user to browse through the one or more topic categories to discover communication channels with relevant media content.

Example 12 is the computer-implemented method of example(s) 1-11, further comprising: detecting a current context of a user based on user data, including location, time, or user activity data; generating one or more contextually relevant topics based on a user context; and presenting contextually relevant topics on the user device to facilitate passive browsing of topics.

Example 13 is the computer-implemented method of example(s) 1-12, further comprising: generating a set of suggested topics based on a historical analysis of past interactions of a user with recommended communication channels; and presenting the set of suggested topics on the user device for passive browsing.

Example 14 is the computer-implemented method of example(s) 1-13, further comprising: enabling a user to follow one or more topics of interest, wherein a followed topic generates automatic notifications when new media content related to the followed topic becomes available on any of the communication channels; and presenting the followed topics and related media content updates on the user device.

Example 15 is the computer-implemented method of example(s) 1-14, wherein the one or more keywords are aggregated into popular topics over a designated time interval, further comprising: providing a visual interface on the user device displaying an interactive timeline of popular topics, enabling a user to browse historical topics from specific times or events.

Example 16 is the computer-implemented method of example(s) 1-15, wherein the one or more recommended communication channels are further generated based on: a social component in which topics that are being actively browsed or interacted with by other users in a social network are suggested for browsing on the user device.

Example 17 is the computer-implemented method of example(s) 1-16, further comprising: generating a visual map of topics based on semantic relationships between the one or more keywords, allowing a user to browse related topics in a graph or network-style interface.

Example 18 is the computer-implemented method of example(s) 1-17, further comprising: generating one or more “explore” or “discover” lists based on recent media content across various categories of interest, enabling users to passively explore topics without a predefined search query.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 602) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 500 of FIG. 5). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving an identification of a set of communication channels presenting media content;
identifying current media content being presented over the set of communication channels;
generating one or more keywords associated with the current media content, wherein the one or more keywords are generated by a machine-learning model trained to interpret natural language associated with the current media content;
receiving, from a user device, a search query;
generating one or more recommended communication channels, wherein the one or more recommended communication channels are associated with one or more associated keywords similar to the search query; and
presenting the one or more recommended communication channels on the user device.

2. The computer-implemented method of claim 1,
generating, according to the one or more keywords, a subset of communication channels, wherein the subset of communication channels is associated with a duration of time;
after the duration of time, identifying updated current media content being presented over the subset of communication channels; and
generating one or more updated keywords associated with the current media content.

3. The computer-implemented method of claim 1, further comprising:
receiving, from the user device, feedback associated with the one or more recommended communication channels; and
updating the machine-learning model according to the feedback.

4. The computer-implemented method of claim 3, wherein the machine-learning model was trained using transfer learning.

5. The computer-implemented method of claim 1, wherein the one or more keywords are generated by receiving data from the set of communication channels.

6. The computer-implemented method of claim 1, wherein the one or more recommended communication channels are further generated based on user data, wherein the user data includes at least a user profile associated with the user device.

7. The computer-implemented method of claim 1, wherein the one or more keywords comprises at least one of a song title, a song categorization, a topic of discussion, a subject matter, names of one or more hosts, original broadcast location of a media source, or title of programming.

8. A system comprising:
one or more processors; and
a non-transitory computer-readable medium storing instructions that, when executed by the one or more processors, cause the one or more processors to:
receive an identification of a set of communication channels presenting media content;
identify current media content being presented over the set of communication channels;
generate one or more keywords associated with the current media content, wherein the one or more keywords are generated by a machine-learning model trained to interpret natural language associated with the current media content;
receive, from a user device, a search query;
generate one or more recommended communication channels, wherein the one or more recommended communication channels are associated with one or more keywords similar to the search query; and
present the one or more recommended communication channels on the user device.

9. The system of claim 8, wherein the instructions further cause the one or more processors to:
generate, according to the one or more keywords, a subset of communication channels, wherein the subset of communication channels is associated with a duration of time;
after the duration of time, identify updated current media content being presented over the subset of communication channels; and
generate one or more updated keywords associated with the current media content.

10. The system of claim 8, wherein the instructions further cause the one or more processors to:
receive, from the user device, feedback associated with the one or more recommended communication channels; and
update the machine-learning model according to the feedback.

11. The system of claim 10, wherein the machine-learning model was trained using transfer learning.

12. The system of claim 8, wherein the one or more keywords are generated by receiving data from the set of communication channels.

13. The system of claim 8, wherein the one or more recommended communication channels are further generated based on user data, wherein the user data includes at least a user profile associated with the user device.

14. The system of claim 8, wherein the one or more keywords comprises at least one of a song title, a song categorization, a topic of discussion, a subject matter, names of one or more hosts, original broadcast location of a media source, or title of programming.

15. A non-transitory computer-readable medium storing instructions that when executed by one or more processors cause the processors to:
receive an identification of a set of communication channels presenting media content;
identify current media content being presented over the set of communication channels;
generate one or more keywords associated with the current media content, wherein the one or more keywords are generated by a machine-learning model trained to interpret natural language associated with the current media content;
receive, from a user device, a search query;
generate one or more recommended communication channels, wherein the one or more recommended communication channels are associated with one or more keywords similar to the search query; and
present the one or more recommended communication channels on the user device.

16. The non-transitory computer-readable medium of claim 15, wherein the instructions further cause the one or more processors to:
generate, according to the one or more keywords, a subset of communication channels, wherein the subset of communication channels is associated with a duration of time;
after the duration of time, identify updated current media content being presented over the subset of communication channels; and
generate one or more updated keywords associated with the current media content.

17. The non-transitory computer-readable medium of claim 15, wherein the instructions further cause the one or more processors to:
receive, from the user device, feedback associated with the one or more recommended communication channels; and
update the machine-learning model according to the feedback.

18. The non-transitory computer-readable medium of claim 17, wherein the machine-learning model was trained using transfer learning.

19. The non-transitory computer-readable medium of claim 15, wherein the one or more keywords are generated by receiving data from the set of communication channels.

20. The non-transitory computer-readable medium of claim 15, wherein the one or more recommended communication channels are further generated based on user data, wherein the user data includes at least a user profile associated with the user device.
